(19) United States
(12) Patent Application Publication
(10) Pub. No.: US 2026/0329638 A1
(43) Pub. Date: Oct. 22, 2026

(54) Method for High-Volume Data Processing Using Graph-Driven ODS and Topological Scheduling

(71) Applicant: Sandeep Sarngadharan, Bolingbrook, IL (US)

(72) Inventor: Sandeep Sarngadharan, Bolingbrook, IL (US)

(21) Appl. No.: 19/685,169

(22) Filed: May 22, 2026

(51) Int. Cl. G06F 9/48; G06F 11/30

(52) U.S. Cl. CPC G06F 9/4881; G06F 11/3051

(57) ABSTRACT

A method for high-volume data processing using graph-driven operational data storage and topological scheduling is disclosed. The method includes receiving a plurality of data processing tasks associated with datasets received from one or more data sources and generating a directed dependency graph representing execution dependencies among the plurality of data processing tasks. Operational task data and dependency metadata are stored within an operational data store (ODS). The method further includes identifying executable processing tasks based on dependency completion states and performing topological scheduling to determine dependency-consistent execution ordering. Executable processing tasks are executed across distributed computing resources, and execution states are updated within the operational data store upon task completion. The directed dependency graph is iteratively traversed to dynamically identify additional executable tasks for parallel or sequential execution. The disclosed architecture improves dependency-aware workflow orchestration, reduces computational redundancy, improves throughput, reduces execution latency, and enhances distributed resource utilization and scalability.

### FIELD OF INVENTION

The present disclosure generally relates to the field of large-scale data processing and distributed computing. More particularly, the present disclosure relates to a method for high-volume data processing using a graph-driven operational data store (ODS) architecture integrated with topological scheduling for dependency-aware execution of data processing tasks. The disclosed method further relates to orchestration of interconnected data transformation workflows, optimized execution sequencing, parallel processing, and efficient management of complex data dependencies in high-throughput computing environments.

### BACKGROUND

The exponential growth of digital platforms, enterprise applications, cloud-native infrastructures, Internet-of-Things (IoT) ecosystems, financial transaction systems, and large-scale analytical environments has resulted in generation of massive volumes of interconnected data requiring continuous processing across distributed computing infrastructures. Modern computing environments frequently execute complex data workflows involving ingestion, transformation, validation, aggregation, synchronization, and analytical operations across multiple heterogeneous data sources and computational nodes. Efficient coordination of such processing operations has become increasingly challenging due to continuously evolving task dependencies, dynamic execution conditions, and scalability requirements associated with high-volume data environments.

Conventional data processing architectures generally utilize sequential workflow pipelines, rule-based orchestration systems, or static execution frameworks for managing processing tasks. Existing systems often depend on predefined execution sequences configured manually by administrators or developers. Such approaches typically operate efficiently only for relatively simple workflows having limited dependency relationships. However, when deployed in large-scale distributed processing environments involving interconnected processing stages and dynamically changing datasets, conventional architectures frequently experience substantial inefficiencies in execution management and computational resource allocation.

In many existing implementations, workflow execution mechanisms fail to accurately model dependency relationships between processing tasks. Absence of structured dependency representation frequently causes premature execution of dependent operations, redundant task invocation, propagation delays associated with intermediate processing outputs, and repeated recomputation of previously processed data segments. Such inefficiencies significantly increase execution latency and computational overhead in large-scale processing systems.

Further, traditional orchestration systems commonly rely on queue-based schedulers, priority-driven execution engines, time-triggered workflows, or event-triggered processing mechanisms. Although such approaches provide basic task execution coordination, they generally lack intelligent dependency-aware scheduling capabilities suitable for managing highly interconnected processing operations. Existing scheduling mechanisms frequently fail to determine optimized execution sequences for large dependency structures distributed across multiple computational resources. Consequently, processing systems often experience resource contention, processor idle time, unbalanced workload distribution, synchronization bottlenecks, and inefficient utilization of available computing infrastructure.

Large-scale distributed computing systems additionally encounter significant challenges associated with parallel execution of dependent processing tasks. Existing workflow systems often process tasks in rigid sequential order despite availability of independent executable operations capable of parallel execution. Failure to dynamically identify dependency-independent tasks reduces throughput and limits scalability of distributed processing environments. In high-volume computing systems, such limitations may adversely affect real-time responsiveness, operational efficiency, and processing consistency.

Operational Data Store (ODS) architectures are widely adopted for maintaining integrated operational datasets received from multiple heterogeneous sources including enterprise databases, cloud applications, streaming systems, sensor networks, and transactional infrastructures. Conventional ODS implementations generally function as centralized repositories for near-real-time operational data consolidation and retrieval. However, existing ODS systems typically lack integrated graph-driven execution management mechanisms capable of representing relationships among interconnected processing operations. Existing architectures further fail to provide coordinated dependency traversal and optimized execution scheduling for complex workflow environments.

Additionally, modern data processing infrastructures frequently require execution of workflows represented by large dependency graphs comprising multiple interconnected transformation and processing stages. Existing systems often lack efficient techniques for traversing dependency structures while preventing cyclic execution conflicts and inconsistent processing sequences. In absence of robust dependency-resolution mechanisms, distributed execution systems may encounter deadlocks, repeated recomputation cycles, inconsistent state propagation, incomplete execution chains, and non-deterministic workflow behavior.

Another technical limitation associated with conventional systems relates to ineffective scalability under continuously increasing data volumes. Existing scheduling frameworks often exhibit degraded performance when handling dynamically evolving workflows involving thousands or millions of interdependent processing operations. Such limitations increase memory utilization, scheduling overhead, network communication delays, and processing bottlenecks within distributed computing environments.

Further, existing workflow management systems frequently lack mechanisms for dynamically identifying executable processing stages based on completion states of predecessor tasks represented within dependency structures. Conventional schedulers generally execute tasks using static execution definitions rather than adaptive graph-driven execution sequencing. As a result, processing environments may suffer from delayed execution propagation, reduced concurrency, and inefficient orchestration of distributed computational resources. Existing technologies also provide limited support for unified integration of graph-based dependency modeling with operational data management and execution scheduling within a common processing framework. Absence of such integrated architectures complicates synchronization of processing states, dependency validation, task orchestration, and execution monitoring across distributed infrastructures.

Accordingly, there exists a need for an improved method for high-volume data processing capable of utilizing graph-driven operational data storage and topological scheduling techniques for dependency-aware execution management. There further exists a need for a scalable processing architecture capable of dynamically determining executable processing sequences, enabling optimized parallel execution, reducing computational redundancy, minimizing execution latency, improving throughput, and enhancing resource utilization across distributed computing environments handling large-scale interconnected data workflows.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a method for high-volume data processing using a graph-driven operational data store (ODS) architecture integrated with topological scheduling for dependency-aware execution of data processing tasks. The disclosed method further relates to orchestration of interconnected data transformation workflows, optimized execution sequencing, parallel processing, and efficient management of complex data dependencies in high-throughput computing environments.

In one aspect, the disclosed method includes receiving a plurality of data processing tasks associated with one or more datasets obtained from heterogeneous data sources including enterprise databases, cloud-based applications, transactional systems, streaming infrastructures, distributed storage repositories, and Internet-of-Things (IoT) devices. The method further includes generating a directed dependency graph representing execution relationships among the plurality of data processing tasks, wherein nodes correspond to processing tasks and edges correspond to dependency relationships between predecessor tasks and successor tasks. The plurality of data processing tasks may include data ingestion operations, transformation operations, aggregation operations, synchronization operations, validation operations, analytical processing operations, or combinations thereof.

In another aspect, the disclosed method includes storing operational task metadata, dependency information, execution states, workflow progression information, intermediate processing outputs, resource allocation information, and execution logs within an operational data store (ODS). The operational data store maintains synchronized workflow state information associated with execution of interconnected processing tasks across distributed computing environments.

In another aspect, the disclosed method includes identifying executable processing tasks based on completion states of predecessor dependencies represented within the directed dependency graph. The method further includes performing topological scheduling to determine dependency-consistent execution ordering of the plurality of data processing tasks through acyclic dependency traversal of the directed dependency graph. In certain embodiments, the disclosed system detects cyclic dependency conditions within the directed dependency graph prior to execution scheduling to prevent inconsistent workflow execution sequences and dependency conflicts.

In another aspect, dependency-independent processing tasks are selectively executed in parallel across distributed computing resources to improve throughput, reduce execution latency, and optimize resource utilization. The disclosed system may dynamically allocate computational resources according to dependency-aware workload distribution criteria associated with processing complexity, dependency depth, resource availability, workload distribution states, or workflow criticality.

In another aspect, the disclosed technology includes iterative traversal of the directed dependency graph to dynamically determine additional executable processing tasks responsive to completion of predecessor tasks. Execution states and dependency status information are continuously updated within the operational data store to maintain synchronized workflow progression across distributed processing environments. In certain embodiments, the disclosed system dynamically modifies the directed dependency graph responsive to insertion, deletion, or modification of one or more processing tasks associated with an executing workflow. In certain embodiments, the system selectively re-executes affected processing tasks responsive to modification of dependency relationships, workflow states, processing outputs, or task execution conditions represented within the directed dependency graph.

In certain embodiments, topological scheduling further includes prioritization of executable processing tasks according to dependency depth, processing complexity, execution criticality, resource availability, workload balancing conditions, or workflow priority parameters. The disclosed system may further monitor execution latency, dependency propagation states, throughput metrics, synchronization states, processing bottlenecks, and resource utilization metrics associated with execution of the plurality of data processing tasks.

In another aspect, the disclosed technology provides a system including one or more processors and one or more non-transitory computer-readable storage media storing instructions that, when executed by the one or more processors, cause the system to perform graph-driven dependency modeling, topological scheduling, dependency-aware execution management, distributed task orchestration, and workflow synchronization operations associated with high-volume data processing environments. In another aspect, the disclosed technology provides a non-transitory computer-readable medium storing instructions that, when executed by one or more processors, cause the one or more processors to perform graph-driven dependency management and topological scheduling operations for high-volume distributed data processing workflows.

The disclosed method and system provide several technical advantages over conventional processing architectures, including improved dependency-aware execution management, optimized execution sequencing, enhanced parallel processing capability, reduced computational redundancy, minimized recomputation overhead, improved synchronization efficiency across distributed processing nodes, reduced resource contention, reduced execution latency, improved throughput, scalable workflow orchestration, efficient distributed resource utilization, and improved consistency and reliability in execution of large-scale interconnected data processing operations.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIGS. 1A-1B illustrate a flowchart of a method for high-volume data processing using graph-driven operational data store and topological scheduling, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

The present disclosure, in one or more embodiments, relates to a method for high-volume data processing using a graph-driven operational data store (ODS) architecture integrated with topological scheduling for dependency-aware execution of data processing tasks. The disclosed method further relates to orchestration of interconnected data transformation workflows, optimized execution sequencing, parallel processing, and efficient management of complex data dependencies in high-throughput computing environments.

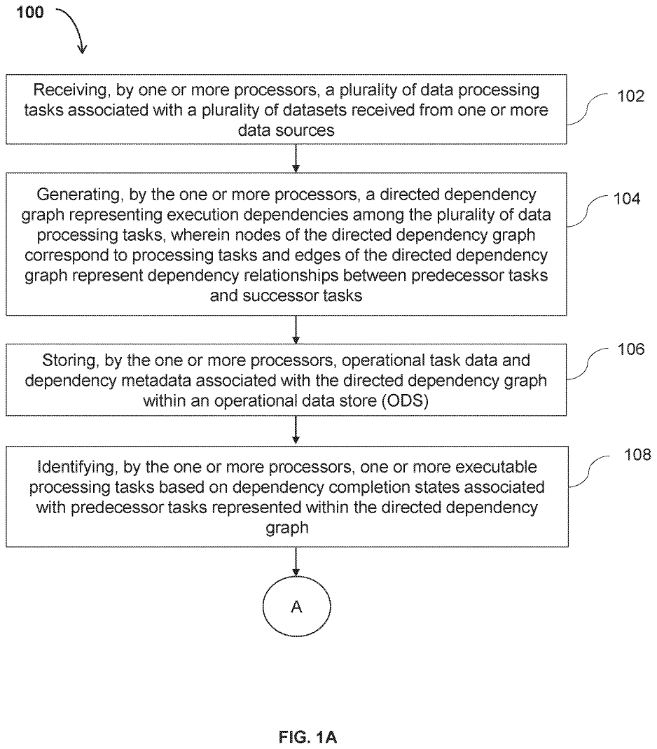

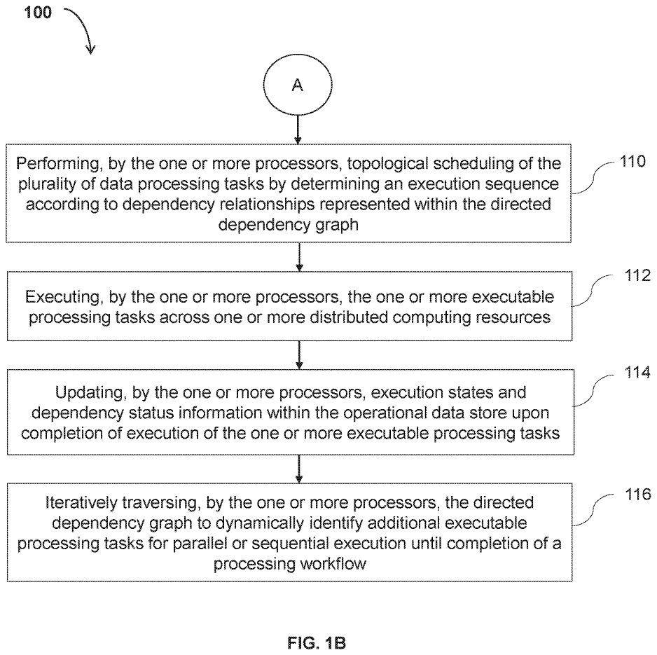

FIGS. 1A-1B illustrate a flowchart 100 of a method for high-volume data processing using graph-driven operational data storage and topological scheduling, according to an embodiment of the present disclosure. The disclosed invention provides a dependency-aware distributed processing architecture configured to process large-scale interconnected workflows associated with heterogeneous datasets received from multiple computing environments. The disclosed architecture utilizes graph-driven dependency modeling and topological scheduling to improve workflow execution consistency, computational efficiency, scalability, and distributed resource utilization associated with high-volume data processing systems.

At step 102, one or more processors receive a plurality of data processing tasks associated with a plurality of datasets received from one or more data sources. In various embodiments, the one or more data sources may include enterprise databases, transactional systems, cloud-based applications, streaming data infrastructures, distributed storage repositories, analytical platforms, Internet-of-Things (IoT) devices, application programming interfaces (APIs), event-streaming systems, or external computing environments.

In various embodiments, the plurality of data processing tasks may include ingestion operations, extraction operations, transformation operations, synchronization operations, aggregation operations, validation operations, indexing operations, enrichment operations, analytical processing operations, reporting operations, machine-learning-related operations, or combinations thereof. The received processing tasks may correspond to independent workflows or interconnected multi-stage execution pipelines associated with distributed processing environments.

At step 104, the one or more processors generate a directed dependency graph representing execution dependencies among the plurality of data processing tasks. Nodes of the directed dependency graph correspond to processing tasks, execution stages, workflow modules, or processing operations, whereas directed edges correspond to dependency relationships between predecessor tasks and successor tasks.

In an embodiment, generation of the directed dependency graph includes mapping interdependent transformation operations, aggregation operations, validation operations, synchronization operations, or analytical processing operations associated with the plurality of datasets. Dependency relationships may be determined based on workflow definitions, execution rules, schema relationships, metadata associations, event relationships, data lineage information, transformation dependencies, execution policies, or combinations thereof.

The directed dependency graph enables structured representation of workflow execution relationships and dependency propagation paths associated with distributed processing operations. In various embodiments, the dependency graph may be dynamically generated or modified responsive to runtime workflow conditions, dataset modifications, execution failures, configuration updates, or incoming processing requests.

At step 106, the one or more processors store operational task data and dependency metadata associated with the directed dependency graph within an operational data store (ODS). In various embodiments, the operational data store maintains task execution metadata, dependency relationship metadata, execution timestamps, processing state information, workflow progression information, resource allocation information, synchronization states, retry conditions, intermediate processing outputs, completion status indicators, execution logs, node allocation information, fault states, and dependency propagation information associated with execution of the plurality of data processing tasks.

In various embodiments, the operational data store may include relational databases, distributed NoSQL databases, graph databases, in-memory data stores, distributed object repositories, cloud-based storage infrastructures, or hybrid storage architectures configured for synchronized workflow state management and low-latency dependency access.

At step 108, the one or more processors identify one or more executable processing tasks based on dependency completion states associated with predecessor tasks represented within the directed dependency graph. In an embodiment, identifying executable processing tasks includes determining processing tasks having satisfied predecessor dependency conditions represented by incoming edges associated with corresponding graph nodes. The one or more processors analyze completion states associated with predecessor nodes to determine whether dependency requirements associated with successor tasks have been satisfied. In various embodiments, executable processing tasks may correspond to nodes having zero unresolved predecessor dependencies within the directed dependency graph.

At step 110, the one or more processors perform topological scheduling of the plurality of data processing tasks by determining an execution sequence according to dependency relationships represented within the directed dependency graph. In an embodiment, topological scheduling includes performing acyclic dependency traversal to determine dependency-consistent execution ordering associated with the plurality of data processing tasks.

The disclosed system traverses the directed dependency graph to prevent execution conflicts associated with recursive workflow loops, invalid dependency propagation, or cyclic execution chains. In various embodiments, the disclosed system further performs cyclic dependency detection prior to workflow execution scheduling to prevent dependency deadlocks and inconsistent workflow execution states.

In an embodiment, topological scheduling further includes prioritizing execution of processing tasks according to dependency depth, execution urgency, workflow criticality, processing complexity, resource availability, workload balancing conditions, latency requirements, service-level objectives, or combinations thereof.

At step 112, the one or more processors execute the one or more executable processing tasks across one or more distributed computing resources. In various embodiments, the distributed computing resources may include distributed processing nodes, cloud computing infrastructures, virtualized execution environments, cluster computing systems, edge processing devices, container orchestration platforms, distributed execution engines, or combinations thereof. In an embodiment, multiple dependency-independent processing tasks are simultaneously executed across a plurality of distributed processing nodes to improve throughput, reduce execution latency, improve scalability, and optimize distributed resource utilization.

In various embodiments, execution of the plurality of data processing tasks further includes allocating computational resources according to dependency-aware workload distribution criteria. The workload distribution criteria may include dependency depth, execution complexity, processor utilization, memory availability, storage throughput, network bandwidth utilization, execution priority, workflow criticality, latency requirements, or combinations thereof.

At step 114, the one or more processors update execution states and dependency status information within the operational data store upon completion of execution of the one or more executable processing tasks. In various embodiments, updated execution states may include queued states, running states, completed states, retry states, failed states, synchronization states, dependency propagation states, partially completed states, or workflow progression states associated with execution of the processing workflow. In an embodiment, updating the execution states includes storing completion status indicators corresponding to nodes of the directed dependency graph to enable dependency-aware propagation of execution states across interconnected workflow segments.

At step 116, the one or more processors iteratively traverse the directed dependency graph to dynamically identify additional executable processing tasks for parallel or sequential execution until completion of the processing workflow. In an embodiment, iterative traversal of the directed dependency graph includes recalculating executable task sets responsive to completion of predecessor processing tasks. Responsive to completion of predecessor nodes, dependency conditions associated with successor nodes are recalculated to determine newly executable processing tasks within the processing workflow.

In various embodiments, the one or more processors dynamically update the directed dependency graph responsive to insertion, deletion, or modification of one or more data processing tasks associated with the processing workflow. Dynamic graph modification enables adaptive workflow orchestration responsive to runtime execution conditions, evolving workflow requirements, schema changes, execution failures, or dataset modifications. In an embodiment, the one or more processors selectively re-execute one or more affected processing tasks responsive to detection of modified dependency relationships within the directed dependency graph. Selective re-execution limits recomputation to dependency-affected workflow segments and reduces redundant processing overhead associated with large-scale workflow execution.

In various embodiments, the one or more processors monitor execution latency, throughput metrics, dependency propagation states, synchronization conditions, workload balancing conditions, retry statistics, fault occurrence metrics, processor utilization levels, memory consumption metrics, network communication metrics, or resource utilization states associated with execution of the plurality of data processing tasks.

The disclosed graph-driven operational data storage and topological scheduling architecture improves dependency-aware workflow execution, reduces computational redundancy, minimizes recomputation overhead, improves synchronization efficiency across distributed processing nodes, reduces resource contention, improves workload balancing, reduces execution latency, improves throughput, and enhances scalability and reliability associated with execution of large-scale interconnected data processing workflows.

In an embodiment, the disclosed system includes one or more computing devices configured to execute graph-driven workflow orchestration operations associated with high-volume distributed data processing environments. The one or more computing devices may include distributed servers, cloud computing nodes, edge processing devices, virtual machines, containerized execution environments, cluster computing infrastructures, or combinations thereof. Each computing device may include one or more processors, memory units, storage devices, communication interfaces, workflow execution engines, graph traversal engines, dependency analysis modules, scheduling modules, and synchronization modules configured to perform dependency-aware workflow orchestration operations.

In an embodiment, the disclosed system includes an operational data store configured to maintain operational workflow data associated with execution of distributed processing tasks. The operational data store may include relational databases, graph databases, distributed NoSQL databases, in-memory storage infrastructures, distributed object repositories, or hybrid storage architectures configured for synchronized workflow state management and low-latency dependency resolution. In an embodiment, the disclosed system integrates with distributed orchestration platforms, cloud-native workflow systems, distributed execution engines, container orchestration infrastructures, streaming systems, event-processing engines, monitoring systems, machine-learning pipelines, or distributed analytical platforms through APIs, event buses, message queues, publish-subscribe systems, or remote procedure call mechanisms.

In an embodiment, the disclosed invention may be implemented using software instructions stored on one or more non-transitory computer-readable storage media. The software instructions, when executed by one or more processors, cause the one or more processors to perform graph-driven dependency management, topological scheduling, dependency propagation management, workflow synchronization, distributed execution orchestration, resource allocation management, and workflow monitoring operations associated with high-volume data processing workflows.

Although specific embodiments have been described, various structural modifications, architectural variations, scheduling algorithms, graph traversal techniques, workflow orchestration mechanisms, storage implementations, communication protocols, and distributed execution techniques may be implemented without departing from the scope of the disclosed invention as defined by the appended claims.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A method for high-volume data processing using graph-driven operational data storage and topological scheduling, the method comprising:
receiving, by one or more processors, a plurality of data processing tasks associated with a plurality of datasets received from one or more data sources;
generating, by the one or more processors, a directed dependency graph representing execution dependencies among the plurality of data processing tasks, wherein nodes of the directed dependency graph correspond to processing tasks and edges of the directed dependency graph represent dependency relationships between predecessor tasks and successor tasks;
storing, by the one or more processors, operational task data and dependency metadata associated with the directed dependency graph within an operational data store (ODS);
identifying, by the one or more processors, one or more executable processing tasks based on dependency completion states associated with predecessor tasks represented within the directed dependency graph;
performing, by the one or more processors, topological scheduling of the plurality of data processing tasks by determining an execution sequence according to dependency relationships represented within the directed dependency graph;
executing, by the one or more processors, the one or more executable processing tasks across one or more distributed computing resources;
updating, by the one or more processors, execution states and dependency status information within the operational data store upon completion of execution of the one or more executable processing tasks; and
iteratively traversing, by the one or more processors, the directed dependency graph to dynamically identify additional executable processing tasks for parallel or sequential execution until completion of a processing workflow.

2. The method of claim 1, wherein generating the directed dependency graph comprises mapping interdependent data transformation operations, aggregation operations, validation operations, synchronization operations, or analytical processing operations associated with the plurality of datasets.

3. The method of claim 1, wherein identifying the one or more executable processing tasks comprises determining processing tasks having satisfied predecessor dependency conditions represented by incoming edges of corresponding nodes within the directed dependency graph.

4. The method of claim 1, wherein topological scheduling comprises performing acyclic dependency traversal to determine dependency-consistent execution ordering of the plurality of data processing tasks.

5. The method of claim 1, wherein executing the one or more executable processing tasks comprises simultaneously executing multiple dependency-independent processing tasks across a plurality of distributed processing nodes.

6. The method of claim 1, wherein the operational data store stores at least one of task execution metadata, dependency relationship metadata, processing state information, resource allocation information, intermediate processing outputs, or workflow execution logs.

7. The method of claim 1, further comprising detecting, by the one or more processors, cyclic dependency conditions within the directed dependency graph prior to execution scheduling.

8. The method of claim 1, further comprising dynamically updating, by the one or more processors, the directed dependency graph responsive to insertion, deletion, or modification of one or more data processing tasks associated with the processing workflow.

9. The method of claim 1, wherein iteratively traversing the directed dependency graph comprises recalculating executable task sets responsive to completion of predecessor processing tasks.

10. The method of claim 1, wherein executing the plurality of data processing tasks comprises allocating computational resources according to dependency-aware workload distribution criteria.

11. The method of claim 1, further comprising monitoring, by the one or more processors, execution latency, resource utilization, throughput metrics, or dependency propagation states associated with execution of the plurality of data processing tasks.

12. The method of claim 1, wherein the one or more data sources comprise at least one of enterprise databases, cloud-based applications, streaming data systems, Internet-of-Things (IoT) devices, transactional systems, or distributed storage repositories.

13. The method of claim 1, wherein updating the execution states within the operational data store comprises storing completion status indicators corresponding to nodes of the directed dependency graph.

14. The method of claim 1, further comprising selectively re-executing, by the one or more processors, one or more affected processing tasks responsive to detection of modified dependency relationships within the directed dependency graph.

15. The method of claim 1, wherein topological scheduling further comprises prioritizing execution of processing tasks according to dependency depth, processing complexity, resource availability, or workflow criticality.

16. A system for high-volume data processing using graph-driven operational data storage and topological scheduling, the system comprising:
one or more processors; and
one or more non-transitory computer-readable storage media storing instructions that, when executed by the one or more processors, cause the system to:
receive a plurality of data processing tasks associated with one or more datasets;
generate a directed dependency graph representing dependency relationships among the plurality of data processing tasks;
store operational task metadata and dependency information within an operational data store;
identify executable processing tasks based on dependency completion states associated with predecessor tasks represented within the directed dependency graph;
perform topological scheduling to determine dependency-aware execution ordering of the plurality of data processing tasks;
execute the executable processing tasks across distributed computing resources; and
iteratively update execution states and traverse the directed dependency graph until completion of a workflow execution process.

17. The system of claim 16, wherein the system is configured to execute multiple dependency-independent processing tasks in parallel across a plurality of distributed processing nodes.

18. The system of claim 16, wherein the operational data store is configured to maintain dependency metadata, task execution states, workflow progression information, intermediate processing outputs, and resource utilization information associated with execution of the plurality of data processing tasks.

19. The system of claim 16, wherein the system is configured to dynamically modify the directed dependency graph responsive to workflow reconfiguration events occurring during execution of the plurality of data processing tasks.

20. A non-transitory computer-readable medium storing instructions that, when executed by one or more processors, cause the one or more processors to perform the method of claim 1.
